(19) United States
(12) Patent Application Publication
(10) Pub. No.: US 2026/0142515 A1
(43) Pub. Date: May 21, 2026

(54) ROTATOR MODULE WITH COOLING STRUCTURE

(71) Applicant: HYUNDAI MOBIS CO., LTD., Seoul (KR)

(72) Inventors: Dae Wook KIM, Yongin-si (KR); Yong Hwan KIM, Yongin-si (KR)

(73) Assignee: HYUNDAI MOBIS CO., LTD., Seoul (KR)

(21) Appl. No.: 19/336,701

(22) Filed: Sep. 23, 2025

(30) Foreign Application Priority Data
Nov. 18, 2024 (KR) 10-2024-0164162

(51) Int. Cl. H02K 1/32; H02K 1/276; H02K 9/193

(52) U.S. Cl. CPC H02K 1/32; H02K 1/276; H02K 9/193

(57) ABSTRACT

The present disclosure relates to a rotor module applied to a vehicle. The rotor module with a cooling structure comprises a rotor core disposed in a hollow cylindrical shape, a rotor shaft fixedly inserted into a center of the rotor core and rotates about a center axis of the rotor core and a cooling flow path unit disposed in the rotor core and the rotor shaft and through which cooling oil flows, wherein the cooling flow path unit includes at least one first flow path recessed in a groove shape in an outer surface of the rotor shaft and extending in an axial direction of the rotor shaft.

### CROSS REFERENCE TO RELATED APPLICATION

The present application claims priority to Korean Patent Application No. 10-2024-0164162, filed November 18, 2024, the entire contents of which is incorporated herein for all purposes by this reference.

### BACKGROUND OF THE DISCLOSURE

### Field of the Disclosure

The present disclosure relates to a rotor module applied to a vehicle, and more specifically, to a rotor module with a cooling structure.

### Description of the Related Art

Recently, as heat generation from permanent magnets has increased with the increasing speed of a motor, the cooling performance of a rotor is necessarily required to prevent a decrease in efficiency of the motor. The conventional hollow shafts are used for cooling the motor and lubricating a reducer using a centrifugal force as much as possible through a hollow structure and processing of flow path holes. That is, cooling is performed by supplying oil from the center of rotation and spreading the oil subjected to a centrifugal force toward an outer diameter of a core through the holes.

However, unlike the off-axis type rotor, the conventional on-axis rotor has a problem that, since a drive shaft located within a rotor shaft, internal space utilization is limited, and when the interior of the hollow shaft is used as a flow path, the rotational efficiency of the drive shaft can be reduced. More specifically, the off-axis type hollow shaft has no cooling function of the rotor, and the hollow shaft has been applied to address an NVH issue and reduce its weight, but with the advancement of motor performance, heat generation in the rotor has not been a serious issue. The on-axis type hollow shaft also initially has no cooling function of the rotor and adopts a structure in which a drive shaft passes through the hollow shaft, but with the improved performance of permanent magnets, heat generation and loss issues in the rotor arise, thereby highlighting the need for cooling. In order to respond to such a need, the on-axis type hollow shaft introduces a method of injecting oil into a hollow shaft for cooling of the rotor, but since the drive shaft rotating inside the hollow shaft and cooling oil share a space, there is a concern that the rotation of the shaft can be hindered, resulting in a reduction in driving efficiency.

### Documents of Related Art

(Patent Document 1) Korean Laid-Open Patent No. 10-2024-0081340 (“MOTOR COOLING STRUCTURE”)

### SUMMARY OF THE DISCLOSURE

The present disclosure has been made in efforts to solve the above problems and is directed to providing a rotor module with a cooling structure in which a flow path may be formed on an outer surface of a rotor shaft, thereby establishing an oil supply path from a hollow type shaft to a rotor core, addressing a heat generation issue and a demagnetization issue by directly cooling the rotor core, and enabling both oil supply and lubrication for a clutch of a reducer, and a needle roller bearing (NRB) of a planetary gear, a ravigneaux gear, and the like.

According to one embodiment of the present disclosure, there is provided a rotor module with a cooling structure, including a rotor core formed in a hollow cylindrical shape, a rotor shaft which is fixedly inserted into a center of the rotor core and rotates about a center axis of the rotor core, and a cooling flow path unit which is formed in the rotor core and the rotor shaft and through which cooling oil flows, wherein the cooling flow path unit includes at least one first flow path recessed in a groove shape in an outer surface of the rotor shaft and extending in an axial direction of the rotor shaft.

In addition, the cooling flow path unit may include a second flow path which is a hole formed axially in the rotor core and whose one end communicates with the first flow path, and a third flow path which is a hole formed axially in the rotor core and including an outlet whose one end communicates with the second flow path and the other end communicates with an exterior of the rotor core.

In addition, the other end ofthird flow path may be formed at a location closer to the center of the rotor core than the one end of the third flow path.

In addition, the rotor core may have a magnet embedded therein, the magnet may be provided to have two or more layers spaced apart from each other in the radial direction of the rotor core, and the third flow path may be formed between the layers of the magnet.

In addition, the cooling flow path unit may further include a pipe-shaped leak prevention plate which is stacked between the rotor core and the rotor shaft and has an inner surface in contact with an outer surface of the rotor shaft.

In addition, the leak prevention plate may have communication holes formed at locations where the first flow path and the second flow path communicate with each other.

In addition, the leak prevention plate may be hot press-fitted into the outer surface of the rotor shaft.

In addition, the cooling flow path unit may further include an oil guide whose one end is coupled to one end of the rotor core and the other end extends toward the rotor shaft to cover a portion of the outer surface of the rotor shaft and which is provided to be spaced a predetermined distance from the rotor shaft.

In addition, the oil guide may include a fastening part having one end coupled to the rotor core, and the fastening part may include a coupling portion having a coupling hole formed to pass therethrough in the axial direction of the rotor shaft and one surface in contact with the rotor core, and a fastener which passes through both the coupling hole and the rotor core to fix the fastening part to the rotor core.

In addition, the oil guide may further include a scatter prevention portion formed to extend to cover the rotor shaft at the other end, and the scatter prevention portion may include a first extension formed to extend from the fastening part and formed to extend in the axial direction of the rotor shaft, and a second extension formed to extend from the first extension and formed to extend in the radial direction of the rotor shaft.

In addition, two or more first flow paths may be formed on a surface of the rotor shaft, and each of the first flow paths may have one end located at one end of the rotor shaft and having a different axial length.

### BRIEF DESCRIPTION OF THE DRAWINGS

FIG. 1 is a perspective view showing a cross section of a rotor module with a cooling structure of the present disclosure.

FIG. 2 is a partial perspective view showing a rotor shaft in which a first flow path is formed according to the present disclosure.

FIG. 3 is a partial perspective view showing a cross section of the rotor module with the cooling structure of the present disclosure.

FIGS. 4 and 5 are partial perspective views showing a rotor shaft to which a rotor module with a cooling structure according to a first embodiment of the present disclosure is applied.

FIG. 6 is a partial perspective view showing a rotor module with a cooling structure according to a second embodiment of the present disclosure.

FIG. 7 is a partial cross-sectional view showing the rotor module with the cooling structure according to the second embodiment of the present disclosure.

FIG. 8 is a partial perspective view showing a rotor module with a cooling structure according to a third embodiment of the present disclosure.

FIG. 9 is a partial perspective view showing an example of applying a leak prevention plate to the rotor module with the cooling structure according to the third embodiment of the present disclosure.

### DETAILED DESCRIPTION OF THE DISCLOSURE

Hereinafter, the technical spirit of the present disclosure will be described in more detail with reference to the accompanying drawings. Prior to this, terms or words used in this specification and claims should not be interpreted as limited to their usual or dictionary meanings and should be interpreted as meanings and concepts that conform to the technical idea of the present disclosure based on the principle that the inventor can appropriately define the concepts of the terms in order to describe his or her own Disclosure in the best way.

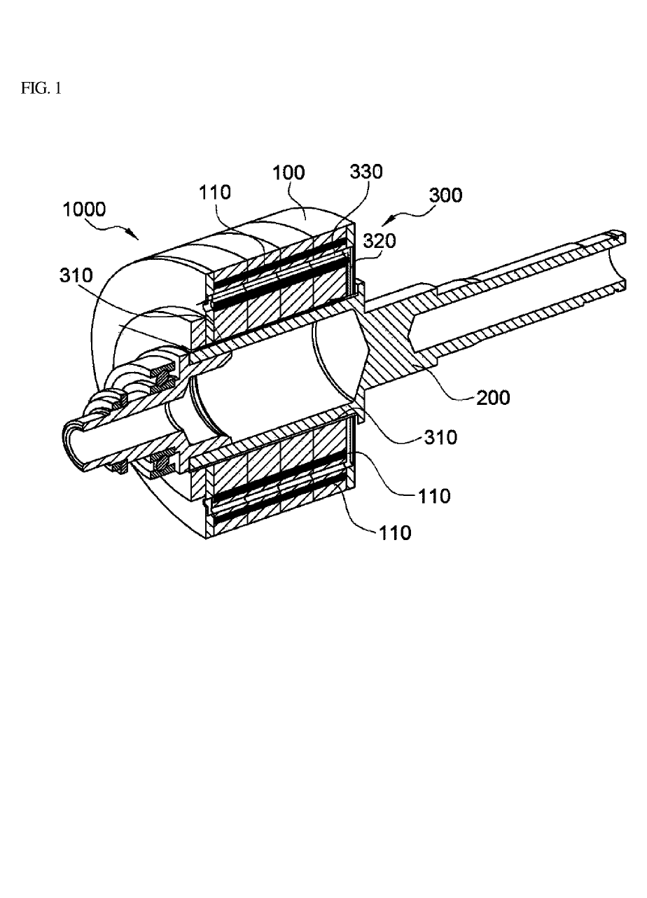

Hereinafter, a basic configuration of a rotor module 1000 with a cooling structure of the present disclosure will be described with reference to FIGS. 1 to 3.

As shown in FIG. 1, the rotor module 1000 with the cooling structure of the present disclosure may include a rotor core 100 and a rotor shaft 200. The rotor core 100 may be formed in a hollow cylindrical shape, and the rotor shaft 200 may be fixedly inserted into the center of the rotor core 100 and may rotate about a center axis of the rotor core 100. In addition, the rotor module 1000 with the cooling structure of the present disclosure may include a cooling flow path unit 300 which is formed in the rotor core 100 and the rotor shaft 200 and through which cooling oil flows. In this case, the cooling flow path unit 300 may guide the cooling oil to flow in a direction of the arrow in FIG. 1.

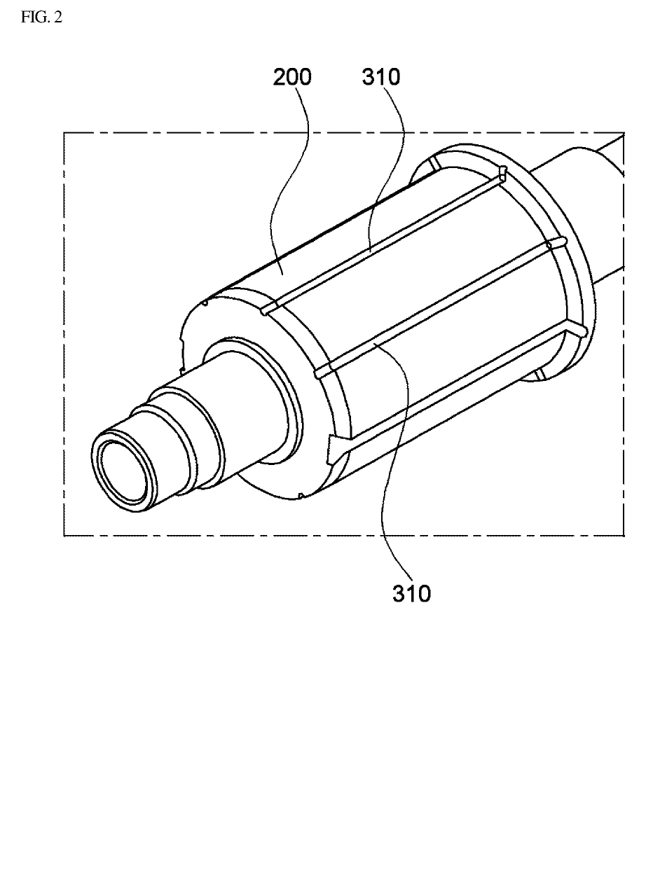

In this case, as shown in FIG. 2, the cooling flow path unit 300 may include at least one first flow path 310 recessed in a groove shape in an outer surface of the rotor shaft 200 and formed in an axial direction of the rotor shaft 200. Two or more first flow paths 310 may be formed, and formation locations of the first flow paths 310 can be easily changed depending on the arrangement of the rotor core 100, the rotor shaft 200, and adjacent components. The rotor module 1000 with the cooling structure of the present disclosure includes a first flow path 310, thereby establishing an oil supply path to the rotor core 100 when applied to the hollow rotor shaft 200, addressing heat generation and demagnetization issues by directly cooling the rotor core 100, and enabling both oil supply and lubrication for a clutch of a reducer, and a needle roller bearing (NRB) of a planetary gear, a ravigneaux gear, and the like.

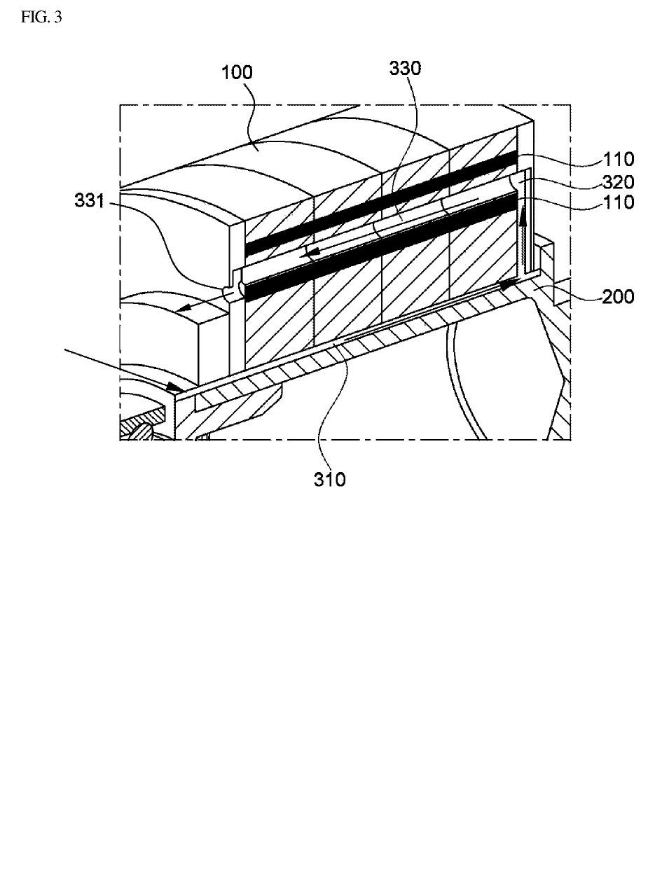

In addition, as shown in FIG. 3, the cooling flow path unit 300 may include a second flow path 320 and a third flow path 330 that communicate with the first flow path 310 and allow cooling oil to flow into the rotor core 100. More specifically, the second flow path 320 is a hole formed radially in the rotor core 100 and may have one end communicating with the first flow path 310. Accordingly, the cooling oil that has cooled the rotor shaft 200 while flowing along the first flow path 310 may move radially outward along the second flow path 320, that is, inward from the rotor core 100, due to a centrifugal force when the rotor shaft 200 rotates. The third flow path 330 is a hole formed axially in the rotor core 100 and may include an outlet 331 whose one end communicates with the other end of the second flow path 320 and the other end communicating with the outside of the rotor core 100.

In this way, since the cooling path unit 300 additionally includes the second flow path 320 and the third flow path 330, the cooling oil introduced through the first flow path 310 may flow into the rotor core 100 to simultaneously cool the rotor shaft 200 and the rotor core 100. In addition, by locating the outlet 331 of the third flow path 330 at the end of the rotor core 100, the cooling oil may also be sprayed onto components such as a clutch, gear, and bearing of the reducer provided at the end of the rotor core 100, thereby achieving both cooling and lubrication effects.

Furthermore, the outlet 331 of the third channel 330 at the other end can be formed at a location closer to the center of the rotor core 100 than one end of the third channel 330. That is, a step may be formed upstream of the outlet 331 in a cooling oil flow direction. Accordingly, the cooling oil discharged from the outlet 331 at the other end of the third flow path 330 may flow toward the center axis of the rotor core 100 and the rotor shaft 200, thereby allowing the cooling oil to be sprayed onto gears and bearings.

In addition, the rotor core 100 may have a magnet 110 embedded therein and having two or more layers spaced apart from each other in the radial direction of the rotor core 100. In this case, the third flow path 330 may be formed between the layers of each magnet 110. Accordingly, the magnet 110, which is the main heat-generating component, can be cooled more efficiently.

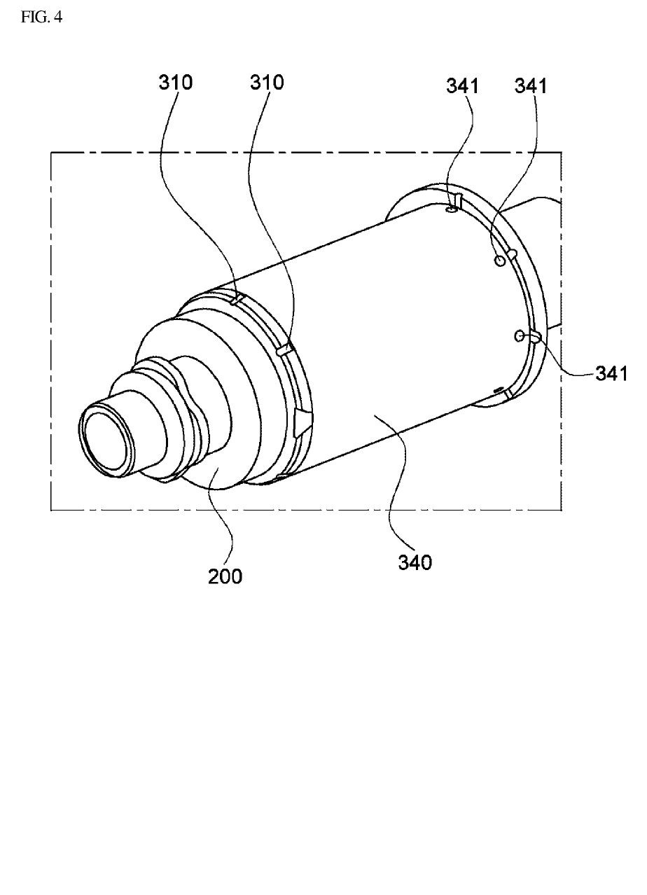

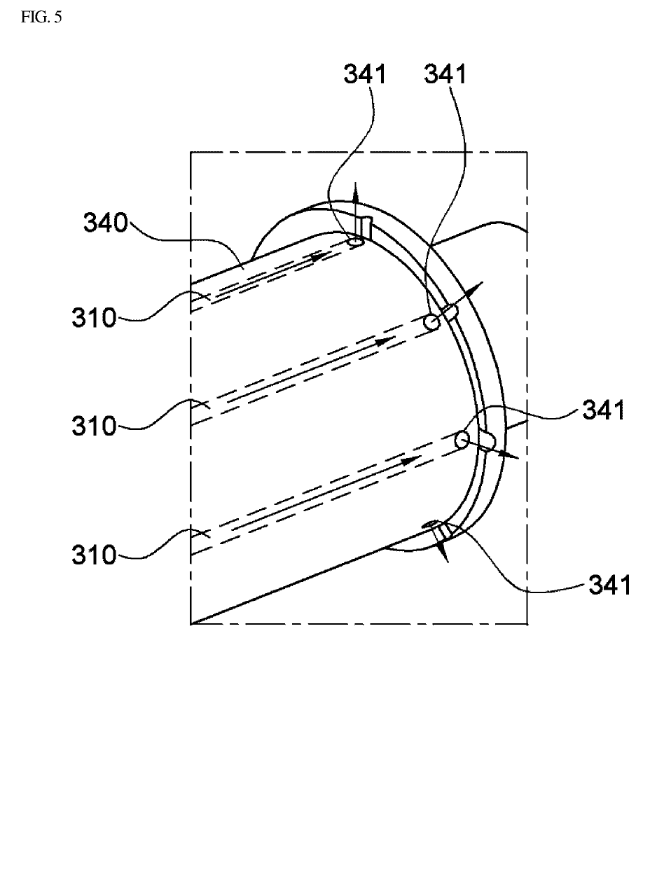

Hereinafter, the rotor module 1000 with a cooling structure according to a first embodiment of the present disclosure will be described in more detail with reference to FIGS. 4 and 5.

In the rotor module 1000 with the cooling structure according to the first embodiment of the present disclosure, as shown in FIG. 4, the cooling flow path unit 300 may further include a leak prevention plate 340 which is stacked between the rotor core 100 and the rotor shaft 200, has an inner surface in contact with the outer surface of the rotor shaft 200, and has a pipe shape. The leak prevention plate 340 may be formed by processing a steel plate. By including the leak prevention plate 340, a space in which the cooling oil flows through the leak prevention plate 340 and the first flow path 310 may be formed, and even when an inner surface of the rotor core 100 is not flat and thus the leak prevention plate 340 may not form the space in which the cooling oil between itself and the first flow path 310 will flow, the leak prevention plate 340 may form a space in which the cooling oil moves axially between itself and the first flow path 310.

In this case, the leak prevention plate 340 is preferably hot pressed-fitted into the outer surface of the rotor shaft 200. Accordingly, the leak prevention plate 340 and the rotor shaft 200 can be more tightly coupled, and the cooling oil can be prevented from leaking out of the first flow path 310 between the rotor shaft 200 and the leak prevention plate 340.

In addition, as shown in FIG. 5, the leak prevention plate 340 may have communication holes 341 perforated at locations where the first flow path 310 and the second flow path 320 communicate with each other. Accordingly, even when the leak prevention plate 340 is press-fitted, the first flow path 310 and the second flow path 320 communicate with each other to allow the cooling oil to be transferred to the rotor core 100.

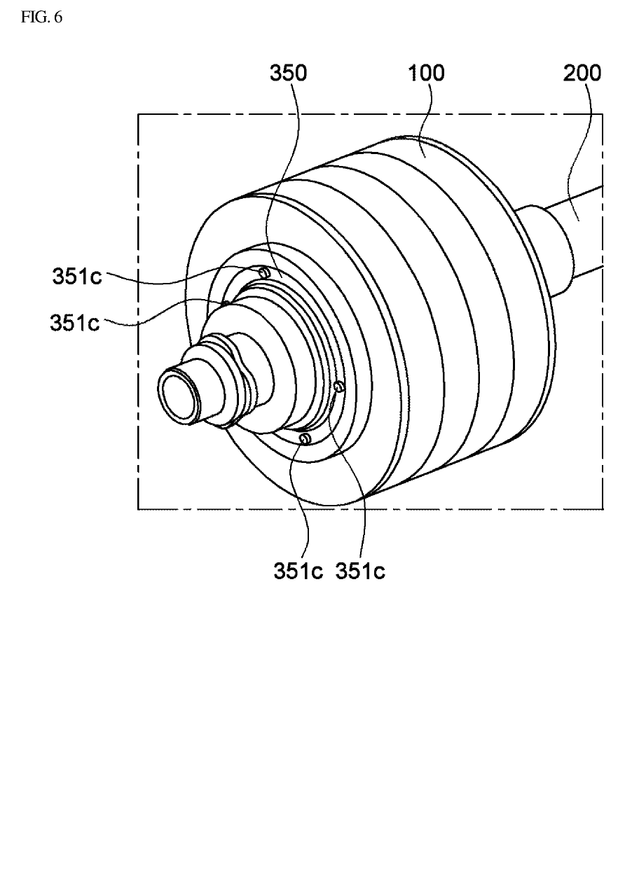

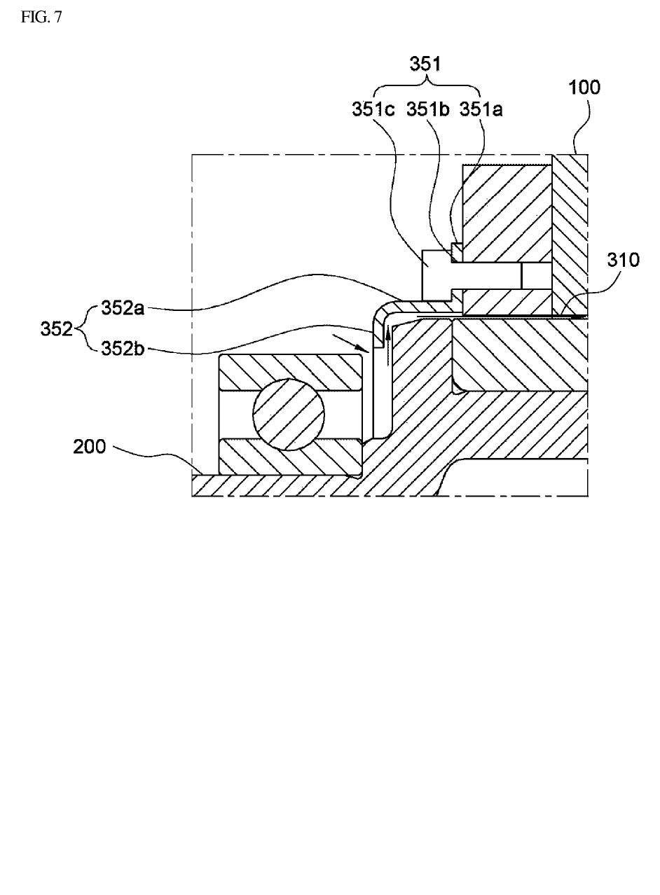

Hereinafter, the rotor module 1000 with a cooling structure according to a second embodiment of the present disclosure will be described in more detail with reference to FIGS. 6 and 7.

In the rotor module 1000 with the cooling structure according to the second embodiment of the present disclosure, as shown in FIG. 6, the cooling flow path unit 300 may further include an oil guide 350 whose one end is coupled to one end of the rotor core 100 and the other end extends toward the rotor shaft 200 to cover a portion of the outer surface of the rotor shaft 200 and which is provided to be spaced a predetermined distance from the rotor shaft 200. More specifically, the oil guide 350 may be coupled to an end of the rotor core 100 or the rotor shaft 200 formed at locations into which a bearing, a reservoir, a retainer, and the like are inserted. The cooling oil may be sprayed onto the end of the rotor shaft 200 or the rotor core 100 to which the oil guide 350 is applied through one of the conventional O-shaped pipe or direct spray port of the reducer, and in this case, the oil guide 350 may serve to guide the flow of the cooling oil to prevent the scattering of the cooling oil or serve to catch the sprayed cooling oil.

More specifically, as shown in FIG. 7, the oil guide 350 may include a fastening part 351 whose one end is coupled to the rotor core 100, and the fastening part 351 may include a coupling portion 351a and a fastener 351c of the rotor shaft 200. More specifically, the coupling portion 351a may have a coupling hole 351b formed to axially pass therethrough and have one surface in contact with the rotor core 100. In this case, the coupling portion 351a may come into contact with one surface of one of a plurality of ends formed on the rotor core 100, and the rotor core 100 may have a hole of the same size formed at a location corresponding to the location where the coupling hole 351b is formed. In addition, the fastener 351c may pass through both the coupling hole 351b and the rotor core 100 to fix the fastening part 351 to the rotor core 100.

In addition, the oil guide 350 may further include a scatter prevention portion 352 having the other end formed to extend to cover the rotor shaft 200. The scatter prevention portion 352 may include a first extension 352a and a second extension 352b formed integrally with each other. More specifically, the first extension 352a may be formed to extend from the fastening part 351 and formed to extend in the axial direction of the rotor shaft 200, and the second extension 352b may be formed to extend from the first extension 352a and formed to extend in the radial direction of the rotor shaft 200. In this way, by including the vertically bent spray prevention portion 352, the cooling oil can be prevented from scattering due to the centrifugal force of the shaft during oil injection, thereby facilitating the injection of the cooling oil.

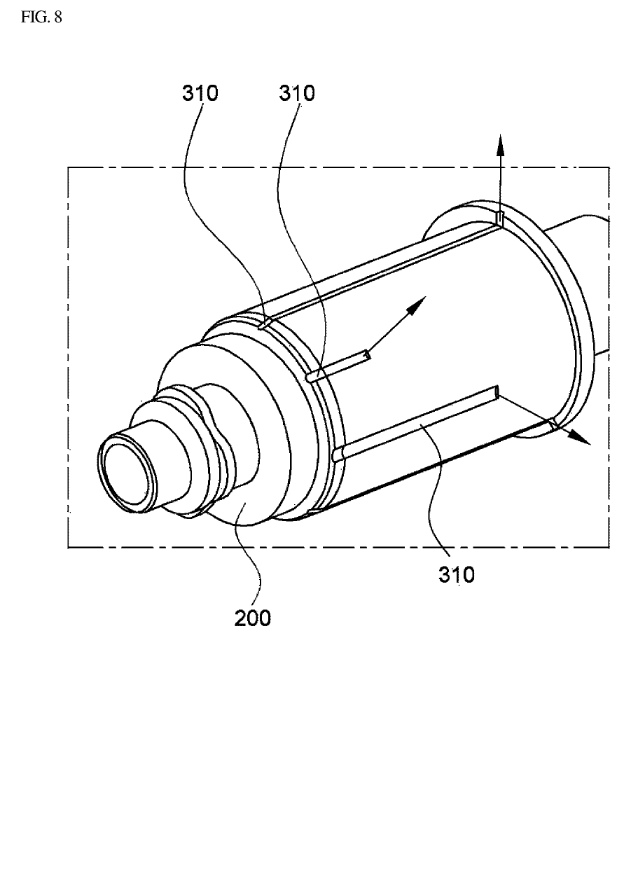

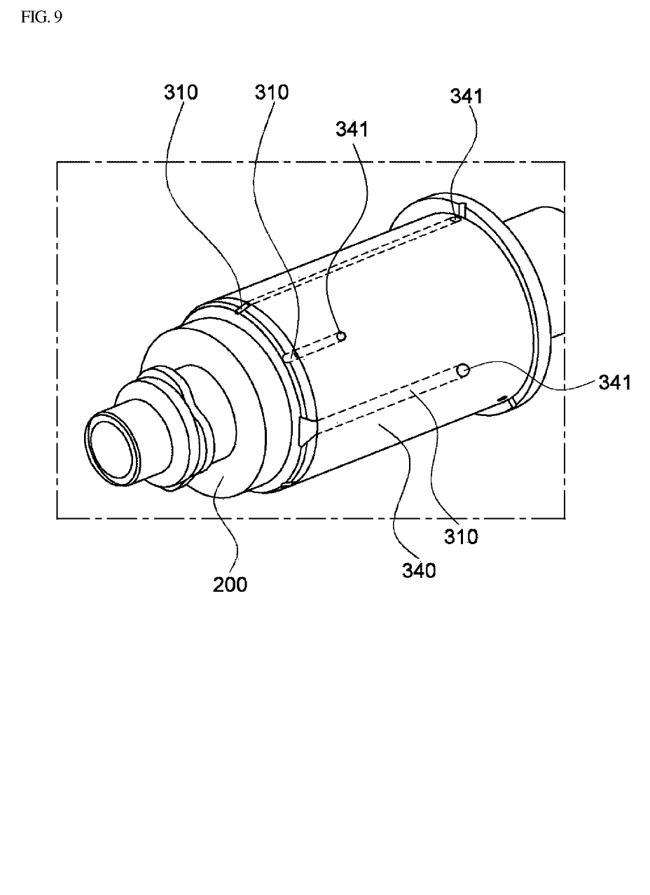

Hereinafter, a third embodiment of the present disclosure will be described in more detail with reference to FIGS. 8 and 9.

As shown in FIG. 8, two or more first flow paths 310 may be formed on the surface of the rotor shaft 200 and each may have a different axial length. In this case, one end of each first flow path 310 may be located at one end of the rotor shaft 200. Accordingly, a spray direction of the cooling fluid flowing along the first flow path 310 may be different to allow the cooling fluid to be sprayed to more diverse locations.

In this case, as shown in FIG. 9, the leak prevention plates 340 of the third embodiment and the first embodiment may be coupled. In this case, the communication holes 341 of the leak prevention plate 340 may be formed at locations corresponding to the other ends of each first flow path 310 to allow the cooling fluid to be discharged from the end of each first flow path 310.

With such a configuration, the rotor module with a cooling structure can be formed such that a flow path can be formed on an outer surface of a rotor shaft, thereby establishing an oil supply path from a hollow type shaft to a rotor core, addressing a heat generation issue and a demagnetization issue by directly cooling the rotor core, and enabling both oil supply and lubrication for a clutch of a reducer, and a needle roller bearing (NRB) of a planetary gear, a ravigneaux gear, and the like.

The technical spirit of the present disclosure should not be construed as limited to the above-described embodiments. Not only the scope of applications is diverse, but also various modifications may be made by those skilled in the art without departing from the gist of the present disclosure as claimed in the claims. Accordingly, these improvements and changes fall within the scope of the present disclosure as long as they are obvious to those skilled in the art.

The technical spirit of the present disclosure should not be construed as limited to the above-described embodiments. Not only the scope of applications is diverse, but also various modifications may be made by those skilled in the art without departing from the gist of the present disclosure as claimed in the claims. Accordingly, these improvements and changes fall within the scope of the present disclosure as long as they are obvious to those skilled in the art.

What is claimed is:

1. A rotor module with a cooling structure, comprising:
a rotor core disposed in a hollow cylindrical shape;
a rotor shaft fixedly inserted into a center of the rotor core and rotates about a center axis of the rotor core; and
a cooling flow path unit disposed in the rotor core and the rotor shaft and through which cooling oil flows,
wherein the cooling flow path unit includes at least one first flow path recessed in a groove shape in an outer surface of the rotor shaft and extending in an axial direction of the rotor shaft.

2. The rotor module of claim 1, wherein the cooling flow path unit includes:
a second flow path in a form of a hole disposed axially in the rotor core, the second flow path including one end communicates with the first flow path; and
a third flow path in a form of a hole disposed axially in the rotor core and including an outlet, the third flow path including one end that communicates with the second flow path and the other end that communicates with an exterior of the rotor core.

3. The rotor module of claim 2, wherein the other end of the third flow path is disposed at a location closer to the center of the rotor core than the one end of the third flow path.

4. The rotor module of claim 2, wherein the rotor core includes a magnet embedded therein,
the magnet is provided to have two or more layers spaced apart from each other in a radial direction of the rotor core, and
the third flow path is disposed between the layers of the magnet.

5. The rotor module of claim 2, wherein the cooling flow path unit further includes a pipe-shaped leak prevention plate which is stacked between the rotor core and the rotor shaft and includes an inner surface in contact with an outer surface of the rotor shaft.

6. The rotor module of claim 5, wherein the pipe-shaped leak prevention plate includes communication holes disposed at locations where the first flow path and the second flow path communicate with each other.

7. The rotor module of claim 5, wherein the pipe-shaped leak prevention plate is hot press-fitted into the outer surface of the rotor shaft.

8. The rotor module of claim 1, wherein the cooling flow path unit further includes an oil guide including one end coupled to one end of the rotor core and the other end extends toward the rotor shaft to cover a portion of the outer surface of the rotor shaft and which is provided to be spaced a predetermined distance from the rotor shaft.

9. The rotor module of claim 8, wherein the oil guide includes a fastening part having one end coupled to the rotor core, and
the fastening part includes:
a coupling portion having a coupling hole formed to pass therethrough in the axial direction of the rotor shaft and one surface in contact with the rotor core; and
a fastener which passes through both the coupling hole and the rotor core to fix the fastening part to the rotor core.

10. The rotor module of claim 9, wherein the oil guide further includes a scatter prevention portion formed to extend to cover the rotor shaft at the other end, and
the scatter prevention portion includes:
a first extension formed to extend from the fastening part and formed to extend in the axial direction of the rotor shaft; and
a second extension formed to extend from the first extension and formed to extend in a radial direction of the rotor shaft.

11. The rotor module of claim 1, wherein two or more first flow paths are disposed on a surface of the rotor shaft, and
each of the first flow paths includes one end located at one end of the rotor shaft and having a different axial length.
